(19) United States
(12) Patent Application Publication
(10) Pub. No.: US 2005/0211755 A1
(43) Pub. Date: Sep. 29, 2005

(54) CONTAINER WITH ADHESIVE SEAL TAPES

(76) Inventor: Karl Peng, Taylor, MI (US)

Correspondence Address: KARL PENG, 22714 COACHLIGHT CIRCLE, TAYLOR, MI, 48180, US

(21) Appl. No.: 10/707,883

(22) Filed: Jan. 20, 2004

(51) Int. Cl. B65D 43/22; B32B 9/00

(52) U.S. Cl. 229/125.39; 428/41.8; 428/42.2

(57) ABSTRACT

A container formed from a preformed blank with four side walls and plurality of flaps on top and bottom of the container has plurality of adhesive tapes attached on the surfaces to assemble and seal the container without cutting off a piece of tape from a separate seal tape. The adhesive tape comprises three zones: two side zones with pressure-sensitive adhesive coating on the surfaces and one middle zone without adhesive coating in the middle of and adjacent to the two side zones. The middle zone of the adhesive tape is delimited by two perforation lines or breaking-off lines between the third zone and the two side zones. One side zone is attached to a surface of the container and the other side zone is covered with a protective strip in the fabricating process. When a user assembles and seals the container, the user peels off the protective strip on the side zone and presses against another surface of the container. When the user wants to open the container, without using a box cutter or a tool, the user can hold a tab at the end of middle zone and tear off the middle zone of the adhesive tape. Pluralities of adhesive tapes are attached to the same locations on the container so the container can be reused multiple times.

### BACKGROUND OF INVENTION

This invention generally relates to a container with adhesive seal tapes attached on the container for assembling, sealing, and assisting in opening the container by pulling off the adhesive seal tapes.

Corrugated and non-corrugated containers have long been made and widely used in various applications. A conventional rectangular such container has four side panels and one side-panel join-flap, and plurality of flaps joined with each side panel. These corrugated or non-corrugated containers are extensively used for packaging, shipping, storing, mailing, and transporting various materials. In the manufacturing process, the containers are folded in flat and stocked together to save shipping and handling space. When an end user wants to use the container, the user has to assemble the container by expanding the four side panels of the container in rectangular shape, swinging and folding the bottom four flaps inward, and sealing two opposite bottom flaps. If necessary, these two bottom flaps can also be sealed by adhering the bottom flaps with their adjacent side panels. After the material is loaded into the container, the user first swings and folds two opposite pairs of the four top flaps inwardly, then seals the two opposite flaps with adhesive tapes by cutting a piece of tape from a separate roll of adhesive tape or from a separate sheet of adhesive tape.

If a user wants to access the material form the container, the user has to break off the sealed adhesive tapes by hand or by using a sharp tool such as a box cutter or a knife to cut the sealing tapes off or cut the container open. It is laboring to cut open the sealed container. It is also unsafe to use a box cutter to cut off the sealing adhesive tape. The sharp edge of the opening tool can result in injury to the user or damage tot he goods or material inside the container if not properly operated. Further more, a damaged container cannot be reused. It is a waste of resource.

Various efforts have been made to assemble and seal the container for packaging, storing, shipping, and mailing products. Such know efforts are disclosed in U.S. Pat. Nos. 1,990,637; 2,011,703; 2,063,999; 2,256,638; 2,349,605; 2,527,685; 2,675,165; 2,678,153; 2,928,582; 2,998,180; 3,130,895; 3,198,420; 3,306,521; 4,114,757; 4,314,639; 4,333,602; 4,441,613; 4,579,277; 4,750,609; 5,219,089; 5,366,142; 5,672,402; 5,722,585; 6,149,052; 6,350,517. European Patent numbers EP1174348 and EP1323635 are also about the similar applications.

The patents cited above use similar methods to seal containers or cartons. These containers have overlapped flaps. Their seal methods are to apply an adhesive substance to the inner surfaces of the flaps and then over-laply to adhere the adhesive-coated inner surfaces of the flaps to the outer surface of other flaps. Despite these various known types of sealing techniques used to seal the containers, these sealing techniques created some problems. First, after the container is sealed, it is not convenient to open the container in that a user needs to break off the bonding between the flaps or directly breaks open the container. Second, the container may not be reusable after open because the user may break off the flaps in order to access the material inside the container. Third, these sealing methods do not have multiple sealing functions to use the container multiple times. Fourth, when a user assembles or seals the container, the user has to cut a piece of adhesive tape to seal the container, inconvenient to the user, especially in situations that the container is required to be opened, examined and resealed.

Adhesive seal tapes with two adhesive coating zones and one adhesive free zone also been described in U.S. Pat. Nos. 2,819,180, 5,366,775, and 5,922,402. U.S. Pat. No. 2,819,180 describes an adhesive tape with two adhesive coating zones and one adhesive coating free zone in the middle. U.S. Pat. No. 5,366,773 describes an adhesive tape which has two adhesive coating zones and one adhesive coating free zone in the middle with holes punched to assist in breaking off in transversal direction. U.S. Pat. No. 5,922,402 describes a manufacturing process to make an adhesive tape with two adhesive coating zones and one adhesive coating free zone in the middle. These inventions do not describe a method to easily tear off the middle zone of the three zone of adhesive tapes.

### SUMMARY OF INVENTION

In this invention the container has four side panels joined by a short side flap to form the four walls of the container. There are eight flaps on the container: four of the flaps on the top of the container and four of the flaps at the bottom, wherein these flaps are joined with the side panels. Four adhesive tapes are attached to the upper and lower portion of two opposite side panels and one adhesive tape is attached on one top flap and one adhesive tape is attached on the bottom flap.

The adhesive tape has three zones: two side zones coated with adhesive material on each side of the adhesive tape and a middle zone free of adhesive coating. Two breaking-off lines are located approximately between the middle zone and the side zones to assist in breaking off the middle zone of the adhesive tape to unseal the container.

When a user uses the container, the user expands the four side panels apart in rectangular shape. Then the user folds first pair of the two opposite bottom flaps and then other pair of the two opposite bottom flaps into the container. Without cutting a piece of adhesive tape to seal the flaps, the users simply pulls off a protective strip on the adhesive tape that is already attached on one of the bottom flap in fabrication, holds and turns to the opposite flap, and presses the pressure-sensitive adhesive tape against the surface of the opposite flap. If necessary, using the same sealing process, the user can also seal the joints between the bottom flaps and the side panels. At this point the bottom of the container is assembled. After the bottom of the container is assembled, the user can load the goods or material into the container. Then the user can seal the top of the container by folding the first pair of the opposite top flaps then the second pair of the opposite top flaps. Without cutting a piece of adhesive tape from an adhesive tape roller, the user simply pulls off the protective strip from the adhesive tape attached on the top flap, folds and turns over to the opposite flap, and presses the pressure-sensitive adhesive tape against the surface of the opposite top flap, and seal the joint between the two top flaps. The adhesive tape bonds the two top flaps together. Using the same method, the user can also seal the joints between the opposite side panels and their adjacent top flaps.

When a user wants to access the goods or material inside the container, the user simply hold the tab at the ends of the adhesive tapes and pull off the adhesive free zone portion from the adhesive tape on the sealed box, making the unsealing process simple and easy without damaging the contents inside the container

The principle object of the present invention is to provide a container with adhesive tapes to adhere at least two flaps of the container together or adhere a flap and a side panel of the container together for fast assembling, sealing, and opening of the container.

Another object of the present invention is to provide an adhesive container which can be fabricated at high speed and stocked in flat condition for easy storage and shipment.

Yet another object of the invention is to provide a container with an adhesive tape which has perforated lines to delimit two adhesive coating zones and one adhesive coating free zone for easily pulling off to open the container.

Yet another object of the invention is to provide a container with plurality of adhesive tapes in the same attachment configuration of the adhesive tapes for multiple use of the container with repeatedly sealing and unsealing requirements.

A further object of the invention is to provide a readily-pulling-off adhesive tape with an adhesive free zone in the middle to ease the opening of the container and eliminate the need of manually cutting off a piece of tape from a separate adhesive tape to seal the container.

Still a further object of the invention is to provide a self-sealing container with adhesive tapes that are simple to construct, economical to manufacture, convenient to stock, fast to assemble, and easy to open.

### BRIEF DESCRIPTION OF DRAWINGS

FIG. 1 illustrates a plain view of a pre-shaped container blank bearing the adhesive tapes on the flaps and the side panels.

FIG. 2 illustrates a simplified perspective view of a particular assembled container of the invention from the blank shown in FIG. 1, with the bottom of the container assembled and the adhesive tapes attached on the top and bottom flaps and the side panels.

FIG. 3 is a simplified perspective view of the sealing process of the container.

FIG. 4 shows a completely sealed container by the adhesive tapes with proliferation lines on the tapes.

FIG. 5 is an enlarged perspective view of the container showing the details of the adhesive tapes on the container and the schematic sealing process.

FIG. 6 is a perspective view of an adhesive tape with proliferation lines in the middle zone and adhesive coatings on the two side zones of the adhesive tape.

FIG. 7 is a cross-sectional view of FIG. 6.

FIG. 8 is a perspective view of an adhesive tape with two middle tapes adhering to a bottom tape coated with adhesive material.

FIG. 9 is a cross-sectional view of FIG. 8.

### DETAILED DESCRIPTION

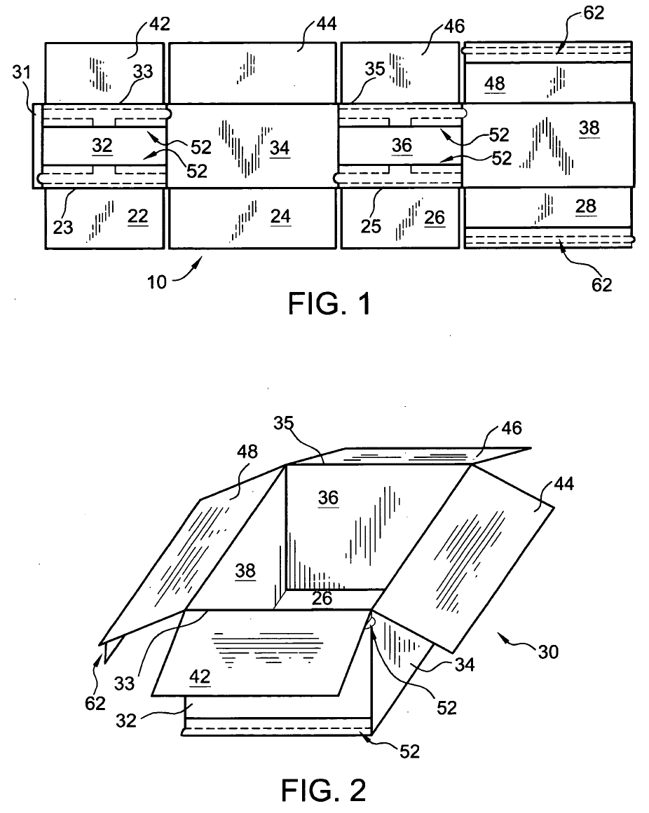

Referring now to FIG. 1, there is illustrated a preformed blank 10 shown in its knocked-down condition at the factory from a single corrugated paperboard or non-corrugated board or the like. The blank 10 is cut, folded, and connected such that the knocked-down article is readily expandable into the container 30 shown in FIG. 2 with minimal effort by the end user and without the need for connectors or additional adhesives except for four adhesive seal tapes 52 and two adhesive seal tapes 62 attached to the blank 10.

The blank 10, as shown in FIG. 1, is for the fully enclosable container 30. However, it should be noted that blanks may likewise be fabricated for containers which are open or which lack top closure flaps. The blank 10 is a conventional corrugated or non-corrugated paperboard or a board made in other materials widely used in industries. The container 30 is preferably generally rectangular, and, therefore, the blank 10 has rectangular side panels and rectangular flaps. There are four side panels: 32, 34, 36, and 38. A short side panel 31 is on the side of the side panel 32. Four bottom flaps 22, 24, 26, and 28 are on the bottom sides of the side panels. Four top flaps: 42, 44, 46, and 48, are on the top side of the side panels. There are folding lines indicated by the hidden lines shown in FIG. 1 forming the hinges between the side panels and between the side panels and the top flaps and between the side panels and the bottom flaps. In FIG. 1 the folding line 33 is between the side panel 32 and the top flap 42. The folding line 23 is between the side panel 32 and the bottom flap 22. The folding line 35 is located between the side panel 36 and the top flap 46. The folding line 25 is located between the side panel 36 and the bottom flap 26. When the short side panel 31 is connected to the free end of the side panel 38 by bending the hinge between the panel 34 and the panel 36, the board becomes a flat, ready-to-use product.

On the blank 10 in FIG. 1, the prefabricated adhesive tapes 52 and 62 are attached to side panels 32 and 36 and flaps 28 and 48. One adhesive tape 52 is attached to the upper portion of the side panel 32 approximately below the folding line 33 and another adhesive tape 52 is attached to the lower portion of the side panel 32 approximately above the folding line 23. Similarly, two adhesive tapes 52 are also attached to the side panel 36: one approximately below the folding line 35 and the other approximately above the folding line 25. One adhesive tape 62 is attached approximately on the far-side edge of the top flap 48 and another adhesive tape 62 is attached approximately on the far side edge of the bottom flap 28 which is on the bottom of the container 30 in FIG. 2.

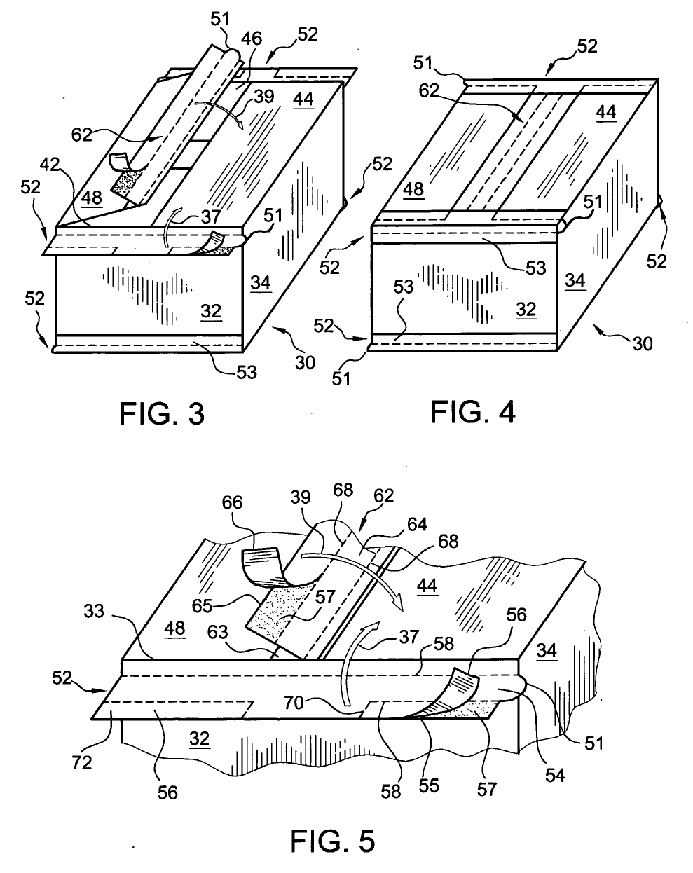

As illustrated in FIG. 2 the container 30 can be constructed for use when the four side panels of the blank 10 are expanded and the bottom four flaps are folded inward and sealed. After the bottom of the container 30 is assembled, the user can load the goods or material into the container 30. FIG. 3 shows the first two opposite top flaps 42 and 46 are swung and folded inward and then the other two opposite top flaps 44 and 48 are swung and folded inward. Then the user pulls off the protective strips 56 and 66, shown in FIG. 5, from the surfaces of the adhesive tapes 52 and 62 and seals the container 30. The completely sealed container 30 is shown in FIG. 4.

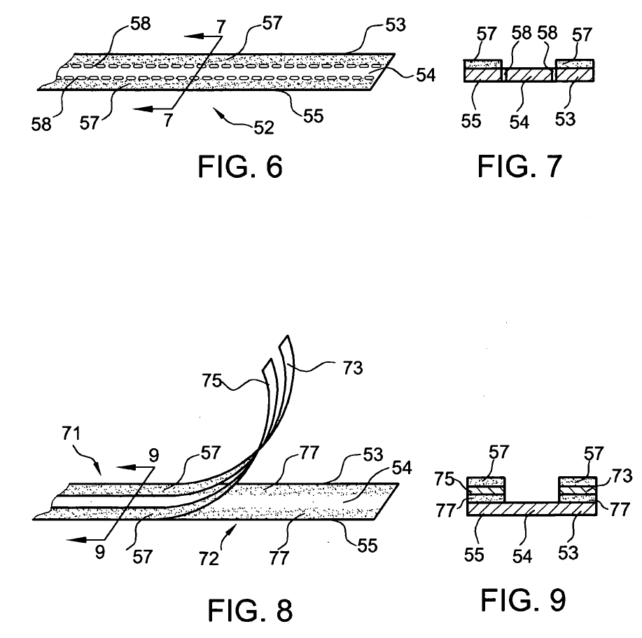

Now referring to FIGS. 5-9 there are illustrations of the detailed structures of the adhesive sealing tapes and their attachments on the container 30. The adhesive sealing tape 52 shown in FIG. 6 has a first zone 53 and a second zone 55 on each side of the tape 52 and a third zone 54 in the middle of and adjacent to the first zone 53 and the second zone 55. The top surface of the first zone 53 and the top surface of second zone 55 are coated with a thin layer of pressure-sensitive adhesive material 57 as shown in FIG. 7. The top surface of the adhesive coating 57 is for bonding the surfaces 53 or 55 to other surfaces on the container 30. On the surface of the third zone 54 there is no adhesive coating on it hence the third zone 54 is not adhesive. Two perforation lines 58 are generally parallel to each other and extend in the longitudinal direction of the tape 52 as shown in FIG. 6. The perforation lines 58 comprise a series of spaced holes punched through the thickness of the tape 52 as shown in FIG. 7. The holes on the perforation lines 58 weaken the strength of the adhesive tape 52 along the perforation lines 58. When a user tears off the third zone 54, the third zone will break off from the weakened perforation lines 58. The shape, sizes, and spacing of the holes on the perforation lines can vary according to the thickness of and the material strength of the tape 52 so the tape 52 have enough strength to hold the two adhered surfaces together, yet easily to be pulled off along the perforation lines 58. As shown in FIG. 7, approximately between the perforation lines 58 it is the third zone 54 which does not have adhesive coating 57 on it. Therefore, when the adhesive tape 52 is applied to a surface, the third zone 54 is free from adhering on the surface.

The perforation lines 58 placed on the adhesive tape 52 re one of the methods to make the tape 52 to be easily broken off along the perforation lines 58 so the third zone 54 can be torn off by a user. An alternative way to achieve this similar easily-breaking-off function is to replace the perforation lines 58 with breaking-off lines wherein the strength of the adhesive tape 52 along the breaking-off lines are weaker than the rest of the adhesive tape 52 so that when a user tears off the third zone 54, the third zone 54 will break off along the breaking-off lines. Making the thickness of the adhesive tape 52 along the breaking-off lines thinner than the rest of the adhesive tape 52 can be easily implemented to achieve such function.

Now referring to FIG. 5, the first zone 53, which is shown in FIG. 4 on the side panel 32, is attached to the upper zone of the side panel 32 approximately below the folding line 33. This attachment of the first zone 53 to the side panel 32 is made during the fabrication of the blank 10 of the container 30. The protective strip 56 covers the second zone 55 to prevent the adhesive coating on the second zone 55 from being contaminated or damaged before use. In order to make it easier to open the container 30, the perforation line 58 in the middle of the adhesive tape 52 near the second zone 55 is discontinued and turned 90 degrees toward the outer edge of the adhesive tape 52 as shown in FIG. 5. This configuration makes the third zone 54 on the side panel as T-shaped delimited by the perforation lines 58. There is also a tab 51 attached at the end of the second zone 54 for a user to pull off the third zone 54 to open the container 30. It is also desirable to have the second zone 55 or the third zone 54 partially attached to the side panel 32 before use to prevent the second zone 55 and the third zone 54 from dangling. This can be achieved by making the protective strip 56 slightly wider than the area of the second zone 55. Then the extra area of the protective strip 56 can be attached to the surface of the side panel 32. But it can be easily separated without damaging the surface of the container 30 or the adhesive tape 52.

The attachment for the adhesive tape 52 at the bottom of the side panel 32 is similar to the attachment of the adhesive tape 52 at the top of the side panel 32. If the container 30 is rotated 180 degrees about an axis perpendicular to the surface of the side panel 32, the adhesive tape 52 at the top will turn to the bottom position. Therefore, the description for the adhesive tape 52 at the bottom of the side panel 32 is the same as that of the adhesive tape 52 at the top of the side panel 32. In the same token, the attachments of the adhesive tapes 52 on the side panel 36 are also the same as the attachments on the side panel 32. It is easy to see that if the container 30 is rotated 180 degrees about an upward axis, the top and bottom adhesive tapes 52 on the side panel 32 will be located in the same positions on the side panel 36.

Now referring to the adhesive tape 62 in FIG. 5, the structure of the tape 62 is very similar to the tape 52 as described in previous embodiment. There are also three zones in the tape 62: the first zone 63 which is coated with adhesive material 57 on the surface and is attached on the flap of the blank 10 of the container 30 in the fabrication process, the second zone 65 which is also coated with the adhesive material 57 on the surface, and the third zone 64, which is free of adhesive material on the surface, is in the middle of and adjacent to the first zone 63 and the second zone 65. The first zone 63 is attached to the top flap 48 generally near the far side edge with the perforation line 68 laying between the first zone 63 and the third zone 65. The protective strip 66 covers the second zone 65 to protect the adhesive coating on the second zone 65 from being contaminated or damaged before use. The protective strip 66 has a surface that can adhere to the coating 57 but can be easily pulled off by an end user.

Similarly, attachment on the adhesive tape 62 on the bottom flap 28 is the same as the attachment of the adhesive tape 62 on the top flap 48. It is easy to see when the container 30 is rotated 180 degrees about an axis perpendicular to the surface of the side flap 32 and then 180 degrees about a upright axis, the top adhesive tape 62 attached to the flap 48 turns to the same position as the attachment of the adhesive tape 62 on the bottom flap 28.

To seal the container 30, the user can swing and fold the top flaps 42 and 46 inward and then swing and fold the top flaps 44 and 48 inward to cover the top opening of the container 30 as illustrated in FIG. 3. After closing the flaps 44 and 48, the user can pull off the protective strip 66 covered on the second zone 65, and expose the pressure sensitive adhesive coating 57. Then the user turns the adhesive tape 62 to the top surface of the flap 44 and presses the second zone 65 against the surface of the flap 44 as the arrow 39 indicated. Under the pressure of the pressing, the adhesive coating 57 on the third zone 65 of the adhesive tape 62 is glued to the top surface of the top flap 44 as shown in FIG. 4. Since the first zone 63, which has already been attached to the top flap 48 in fabrication, is adhered to the top surface of the flap 48 and the third zone 65 is adhered to the top surface of the flap 44. The second zone 64 of the adhesive tape 62 covers the joint between the top flap 44 and the top flap 48. It is also desirable to have the second zone 65 or the third zone 64 partially attached to the top flap 48 before use to prevent the second zone 65 and the third zone 64 from dangling. This can be achieved by making the protective strip 66 slightly wider than the area of the second zone 65. Then the extra area of the protective strip 66 can be attached to the surface of the top flap 48 but can be easily separated from the surface of the flap 48 without damaging the flap 48 or the adhesive tap 62.

After sealing the top flaps 44 and 48, the user can seal the joints between the top flaps 44 and 48 and the side panel 32, and the joint between the top flaps 44 and 48 and the side panel 36. The first zone 53 of the tape 52 is already attached to the upper portion of the side panel 32. To complete the sealing process, the use pulls off the protective strips 56 on the adhesive surface of second zone 55 of the adhesive tape 52 as shown in FIG. 5. Then the user turns the adhesive tape 52 up, folds over the folding line 33 and press against the top surfaces of the top flap 44 and the top flap 48 as indicated by the arrow 37. Since the adhesive tape 52 is pressure sensitive, the adhesive coating zone 57 of the adhesive tape 52 will adhere to the top surfaces of the top flap 44 and the top flap 48.

The sealing process for the adhesive tape 52 on the side panel 36 is the same as the sealing process for the adhesive tape 52 on the side panel 32. The completely sealed container 30 is illustrated in FIG. 4. The sealing of the bottom of the container 30 is the same as the sealing of the top of the container 30.

It is noted that there are different ways to attach the adhesive tape 52 to the container 30. The adhesive tape 52 can also have the first zone 53 to be attached to the top surface of the top flap 44 and the top surface of the top flap 48 near the folding line 33 in the manufacturing process. The second zone 55 can later be sealed by a user to the side panel 32. There are several of combinations of the attachments of the adhesive tapes 52 and 62 on the side panels and the top flaps and the bottom flaps.

This invention also improves the effectiveness of opening the container 30. In conventional methods, when a user wants to open the container 30, the user has to use a sharp tool such as a box cutter or a knife to cut off the sealed adhesive tape 52 and 62 or simply directly cut off the flaps of container 30 to access the goods or material inside the container 30. In this invention the user can simply pull off the third zones 54 on the tape 52 and the third zone 64 of the tape 62 from the sealed tapes 52 and 62. The tab 51 is located at the end of the tape 52 for assisting to hold the third zone 54 and pull the third zone 54 off. To open the container 30, the user simply holds the tab 51 located at the end of the adhesive tape 52, tears up and pulls off the third zone 54 from the adhesive tape 52. The third zone 54 breaks off along the perforation lines 58 because the holes on the adhesive tape 52 weakens the structure and make it easier to break off along the perforation lines 58. After the third zone 54 is pulled off, the first zone 53 stays with the upper portion of the side panel 32. One portion of the second zone 55 stays with the top surface of the top flap 44. Another portion of the second zone 55 stays with the top surface of the top flap 48. The side panel 32 is separated from the top flap 44 and 48.

Similarly, the adhesive tape 52 on the upper portion of the side panel 36 can also be pulled off using the same process as the one pulling off the tape 52 from the side panel 32.

The same tab 51 is also located at the end of tape 62 for easy opening the container. Now the user can hold the tab 51 on the third zone 64 of the adhesive tape 62, tears up and pulls off the third zone 64. The third zone 64 will break off along the perforation lines 68 as shown in the FIG. 4. After the third zone 54 is pulled off, the first zone 63 and the second zone 65 are separated. The first zone 63 stays with the top flap 48 and the second zone 65 stays with the top flap 44.

After the third zones 54 on the upper zone of the side panels 32 and 36 of the adhesive tapes 52, and the third zone 64 of the adhesive tape 62 are pulled off, the top flaps 42, 44, 46, and 48 care free and an be easily unfolded outwardly. The container 30 is opened.

The sealed bottom of the container 30 can also be unsealed using the same process as unsealing the top of the container 30 as described above. If all adhesive tapes 52 and 62 are pulled off, the container 30 can be knocked down to restore its flat state by holding and collapsing the four side panels.

In this invention plurality of adhesive tapes 52 can be attached to the same location for multiple uses. For example, there can be two or more adhesive tapes 52 attached to the upper portion of the side panel 32 and the upper portion of the side panel 36. Two or more adhesive tapes 62 can be attached to the far side edge of the top flap 48. After the first set of the adhesive sealing tapes 52 and 62 have been used, the user can use the second set of the adhesive tapes 52 and 62 to seal the container again. As a result, the container 30 can be used multiple times. This reusability of the container 30 saves material and reduces wastes.

Another alternative embodiment of the easy pulled-off adhesive seal tape 71 is illustrated in FIGS. 8 and 9. The adhesive tape 71 comprises four layers. The first layer is the tape 72 at the bottom. The second layer is an adhesive coating 77 applied on the top surface of the tape 72. The third layer comprises of two tapes 73 and 75 laid side by side with the bottom surface bonded with the top surface of the adhesive coating 77. The fourth layer is the adhesive coating 57, as described in previous paragraphs, coated on the top surface of the tapes 73 and 75. The four layers are placed as the drawing shown in FIG. 8. The tape 72 has three zones as described previously: the first zone 53 coated with adhesive material 57, the second zone 55 coated with adhesive material 57, and the third zone 54 free of adhesive coating, as shown in FIG. 9. The third zone 54 is not adhesive. The tape 73 has the same width as that of the first zone 53 and the tape 75 the same width as that of the second zone 55. The cross-sectional view of the adhesive tape 71 is shown in FIG. 9.

Since the tape 72 is designed to be pulled off from the tape 73 and the tape 75, the bonding between the adhesive coating 77 and the bottom surface of the tapes 73 and 75 are weaker than the bonding between the adhesive coating 77 and the top surfaces of first zone 53 and second zone 55 of the tape 72. It is also desirable for the adhesive coating 57 to have higher adhesion than the adhesive coating 77. It is preferable to have stronger bonding between the adhesive coating 57 and the top surface of the tapes 73 and 75 than the bonding between the bottom surface of the tapes 73 and 75 and the adhesive coating 77. Hence when the adhesive tape 72 is pulled off, the tapes 73 and 75 stay with the surfaces sealed.

1. A container for storing, packaging, shipping, and mailing products, the container comprising:
four side panels sidewardly joined each other, wherein said four side panels can be expanded to form four side walls of said container;
plurality of flaps sidewardly joined with said side panels for closing said container by folding said flaps inwardly along the folding lines between said side panels and said flaps;
an adhesive tape having a first zone for attaching to a first surface of said container and a second zone for attaching to a second surface of said container, wherein said first zone is coated with adhesive material and is attached to said first surface of said container in the fabrication process of said container and wherein said second zone is coated with adhesive material in the fabrication process of said container and is to be attached to said second surface by a user in the assembling and sealing process of said container; and
a strip covering said adhesive material on said second zone for preventing the surface of said second zone from being contaminated or damaged, wherein said strip can be pulled off from said second zone by a user.

2. The container according to claim 1, wherein said adhesive tape further comprises a third zone in said adhesive tape for pulling off by a user to open said container, wherein said third zone is in the middle of and adjacent to said first zone and said second zone and approximately extends to the longitudinal direction of said adhesive tape, wherein said third zone has no adhesive coating on the surface, and wherein said third zone is delimited by a first perforation line approximately between said third zone and said first zone and by a second perforation line approximately between said third zone and said second zone.

3. The container according to claim 2, wherein said first perforation line and said second perforation line comprise plurality of spaced through holes on said adhesive tape.

4. The container according to claim 2, wherein said third zone has a tab at one end of said adhesive tape for holding and pulling off said third zone from said adhesive tape;

5. The container according to claim 1, wherein said adhesive tape further comprises a third zone in said adhesive tape for pulling off by a user to open said container, wherein said third zone is in the middle of and adjacent to said first zone and said second zone and approximately extends to the longitudinal direction of said adhesive tape, wherein said third zone has no adhesive coating on the surface, and wherein said third zone is delimited by a first breaking-off line approximately between said third zone and said first zone and by a second breaking-off line approximately between said third zone and said second zone.

6. The container according to claim 5, wherein said first breaking-off line and said second breaking-off line are constructed so that the strength of said adhesive tape along said first breaking-off line and said second breaking-off line is weaker than the rest of the structure of said adhesive tape.

7. The container according to claim 1, wherein said first surface is the exterior surface of a flap of said container and said second surface is the exterior surface of another flap of said container.

8. The container according to claim 1, wherein said first surface is the surface of a flap of said container and said second surface is the surface of a side panel of said container.

9. An adhesive tape for sealing surfaces comprising:
a first zone coated with adhesive material for attaching to a first surface;
a second zone coated with adhesive material for attaching to a second surface; and
a third zone free of adhesive coating for pulling off by a user to unseal said adhesive tape, wherein said third zone is in the middle of and adjacent to said first zone and said second zone and generally extends parallel to the longitudinal direction of said adhesive tape, and said third zone is delimited by a first breaking-off line approximately between said third zone and said first zone and by a second breaking-off line approximately between said third zone and said second zone.

10. The adhesive tape for sealing surfaces according to claim 9, wherein said first breaking-off line and said second breaking-off line are constructed so that the strength of said adhesive tape along said first breaking-off line and said second breaking-off line are weaker than the rest of said adhesive tape for assisting said third zone to be pulled off.

11. The adhesive tape for sealing surfaces according to claim 9, wherein said first breaking-off line and said second breaking-off line are perforation lines comprising plurality of holes spaced and extended to the longitudinal direction of said adhesive tape.

12. An adhesive tape for sealing surfaces comprising:
a base tape having a first zone coated with adhesive material for bonding to the first surface of a first tape; a second zone coated with adhesive material for bonding to the first surface of a second tape; and a third zone free of adhesive coating for pulling off by a user to unseal said adhesive tape, wherein said third zone is in the middle of and adjacent to said first zone and said second zone and generally extends parallel to the longitudinal direction of said adhesive tape;
said first tape covering said first zone of said base tape, wherein the second surface of said first tape is coated with adhesive material for adhering to a first seal surface; and
said second tape covering said second zone of said base tape, wherein the second surface of said second tape is coated with adhesive material for adhering to a second seal surface.

13. The adhesive tape for sealing surfaces according to claim 12, wherein the adhesive bonding between said first tape and said first seal surface and between said second tape and said second seal surface is stronger than the bonding between said first tape and said base tape and between said second tape and said base tape so that when said base tape is pulled off said first tape stays with said first said seal surface and said second tape stays with said second seal surface.

14. The adhesive tape for sealing surfaces according to claim 12, wherein said third zone of said base has a tab at the end for a user to hold and pull off said base tape from said first tape and said second tape.
